(19) United States
(12) Patent Application Publication
(10) Pub. No.: US 2013/0223919 A1
(43) Pub. Date: Aug. 29, 2013

(54) CONNECTION DEVICE FOR ADJUSTABLE CONNECTION OF MEDICAL EQUIPMENT TO A STATIONARY FIXTURE

(71) Applicant: Jürgen Brecht, Graben-Neudorf (DE)

(72) Inventor: Jürgen Brecht, Graben-Neudorf (DE)

(21) Appl. No.: 13/403,225

(22) Filed: Feb. 23, 2012

(51) Int. Cl. F16C 11/06

(52) U.S. Cl. 403/31

(57) ABSTRACT

A connection device for the adjustable connection of a medical device, preferably a head-restraint, to an attachment of a stationary fixture, preferably an operating table, with the medical device being connectable to one end and the stationary device to the other end of the connection device, and the connection device having at least two holding arms (10a, 10b, 10c) connected via a ball-and-socket joint, in which the first holding arm (10a) has a ball joint socket (110a), the second holding arm (10b) a matching ball joint (12b), and the ball-and-socket joint can be fixed in a desired angular position by an unlockable clamping device having a pre-stressing element, which presses a joint socket (21) against the ball joint (12b) of the second holding arm (10b). The pre-stressing element is a gas pressure spring (17).

### BACKGROUND

The invention relates to a connection device for the adjustable connection of a medical device, preferably a patient head-restraint, to an attachment of a stationary fixture, preferably an operating table, with the medical device being connectable to one end, the stationary fixture to the other end of the connection device, and the connection device comprising at least two holding arms connected (to each other) via a ball-and-socket joint, in which the first holding arm comprises a joint socket, the second holding arm a matching ball joint, and the ball-and-socket joint can be fixed in a desired angular position by an unlockable clamping device, which comprises at least one pre-stressing element, which presses a joint socket against the ball joint of the second holding arm.

Such connection devices may be used to hold body parts, particularly the head of a patient or a medical device, such as an endoscope, hook, or the like in a defined position during a surgical operation. In order to reach the desired position of the auxiliary device or the body part and precisely maintain it during the application the connection device is articulate in all spatial direction and can be fixed when the desired position has been reached.

The present invention is based on DE 10 2007 035 922, which is hereby referenced in its entirety. This connection device of prior art comprises a particular clamping device for the ball-and-socket joint, which operates with a hydraulic transmission and thus creates high clamping forces. It allows a very stable and secure fixation of the body part, upon which the surgical operation is to be performed. This fixation is of particular importance in surgical operations, because a failure of the clamping may have serious consequences, which may lead to severe injuries of the patient.

Examinations of the applicant of the connection device of prior art have now shown that the effectiveness of the clamping device is not lastingly ensured. The precise maintenance of the position of the medical device supported by the connection device is then no longer ensured.

### SUMMARY

The present invention is therefore based on the objective of improving the connection device of prior art with regards to the reliability of its clamping device. Furthermore, the connection device should be characterized in a compact and cost-effective design.

This objective is attained according to the invention in that the pre-stressing element of the clamping device is embodied as a gas pressure spring.

The invention is further based on the acknowledgement that the coil springs used in prior art as pre-stressing elements largely change their tensile force over a relatively small change of length. This means that when the coil spring loses tension the tensile force and thus the clamping force applied upon the ball joint considerably weakens. This particularly applies to the connection device of prior art which operates with a hydraulic clamping force transmission and thus requires relatively long spring travel.

Additionally aggravating in this clamping force transmission is the fact that after extended use a loss of hydraulic fluid can occur in the transmission device, which even further lengthens the spring travel and ultimately the coil spring is no longer capable to create the required clamping force.

Contrary thereto, using the gas pressure spring according to the invention it can be operated with a high overall gas volume in reference to the change of gas volume resulting in the spring travel such that the pressure and thus the change of clamping force is low over the spring travel. The ratio between the change of the gas volume and the overall gas volume beneficially amounts to at least 1:8, particularly at least 1:10. The gas pressure spring according to the invention therefore allows ensuring an almost constant spring force over the entire spring travel.

Another essential advantage of the invention comprises that the spring force can be adjusted in a simple fashion by way of changing the pressure inside the gas chamber of the spring.

The gas pressure spring according to the invention is therefore particularly suitable for such connection devices, which based on their transmission of the clamping force require long spring travel. This equally applies to clamping force transmissions using mechanical means, e.g., particularly by gear trains or the like as well as hydraulic clamping transmissions, which achieve the desired increase in clamping force via pistons having different diameters.

In order to loosen the clamping device the gas pressure spring beneficially acts upon the control piston, which can be impinged from the outside by a counter force against a force created by the gas pressure spring. This counter force is beneficially created hydraulically or pneumatically. It is not mandatory for it to be of such an extent that it exceeds the force created by the gas pressure spring, because depending on the respective application it may be beneficial to reduce the clamping force applied upon the ball-and-socket joint such that a manual adjustment of the ball-and-socket joint is possible against only minor friction forces.

Here, the scope of the invention includes simultaneously introducing the hydraulically or pneumatically created counter force into all holding arms, thus to simultaneously unlock all ball-and-socket joints or instead thereof to select an exclusive unlocking of individual ball-and-socket joints.

In a constructive further development of the clamping device it is recommended that the above-mentioned control piston or another control piston impinged by the gas pressure spring penetrates into the cylinder chamber, which exhibits a considerably larger diameter in reference to the control piston and which comprises a secondary piston with a respectively larger diameter, which on the other side operates either directly as a joint socket for the ball joint or cooperates with such a joint socket. This way, depending on the ratio of the diameter of the control piston in reference to the secondary piston a strong clamping force transmission can be realized in a simple fashion.

In general, standard gaskets to seal the pistons in their respective piston chambers are sufficient. However, in case of particularly high sealing requirements a piston may also be connected via articulate membranes, diaphragms, or the like to the allocated cylinder in an absolutely liquid-tight fashion.

In order to allow adjusting the spring force of the gas pressure spring in a simple fashion it is recommended that the gas pressure spring comprises a fill valve, particularly a check valve, which is easily accessible from the outside even when the gas pressure spring is assembled in the holding arm.

### BRIEF DESCRIPTION OF THE DRAWINGS

Additional features and advantages of the invention are discernible from the description of an exemplary embodiment and from the drawing. Shown here are:

FIG. 1 a perspective illustration of the connection device comprising three holding arms; and

FIG. 2 an enlarged longitudinal cross-section through a holding arm comprising a gas pressure spring and a ball-and-socket joint to a second holding arm adjacent towards the bottom.

### DETAILED DESCRIPTION OF THE PREFERRED EMBODIMENTS

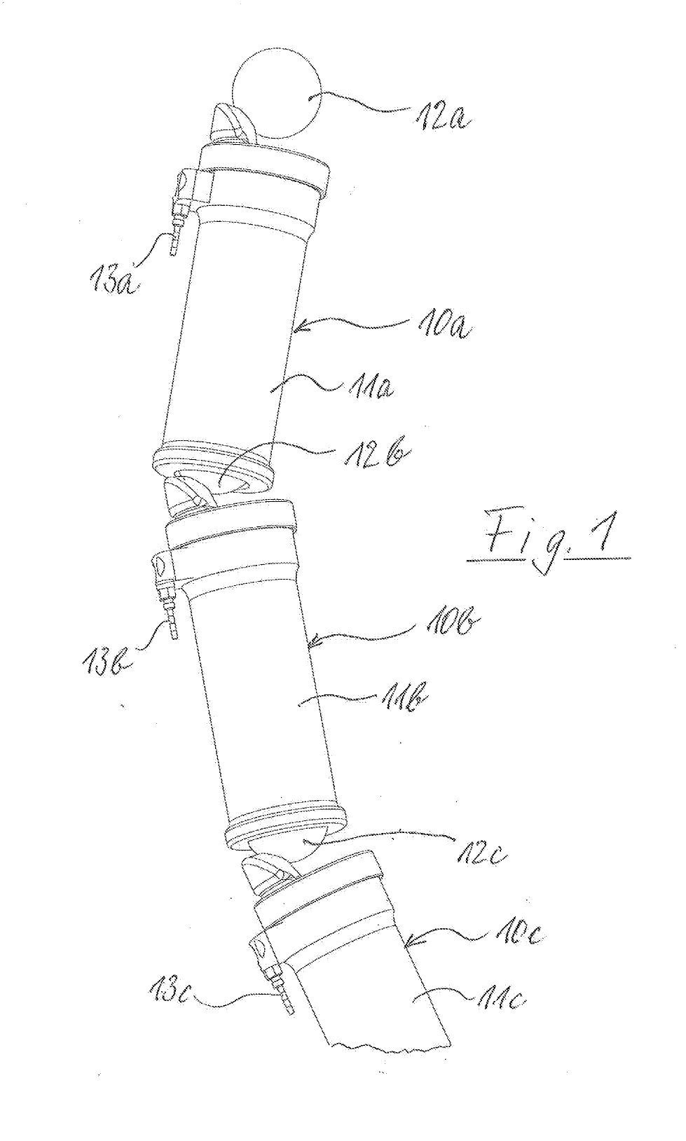

FIG. 1 shows the connection device in a schematic illustration using the example of three holding arms 10a, 10b, and 10c, each connected to each other in an articulate fashion. One end of the connection device may be fastened to an operating table, for example, while the other end may support a head restraint, not shown, for a neurosurgical operation, for example.

Each holding arm 10a, 10b, 10c comprises an approximately cylindrical housing 11a, 11b, 11c, which supports at one of its ends a ball joint 12a, 12b, and/or 12c.

The ball joints are each inserted in joint sockets of the adjacent holding arm and are here supported in a fashion rotational in all directions, however they can be fixed by a clamping device if necessary. This clamping device operates hydraulically; for this purpose, each holding arm comprises a hydraulic connection 13a, 13b, and/or 13c, by which the above-mentioned clamping and/or the unlocking of said clamping can be realized. The control of the hydraulic flow usually occurs via a common foot-operated hydraulic pump or via separate ones connected to the individual support arms.

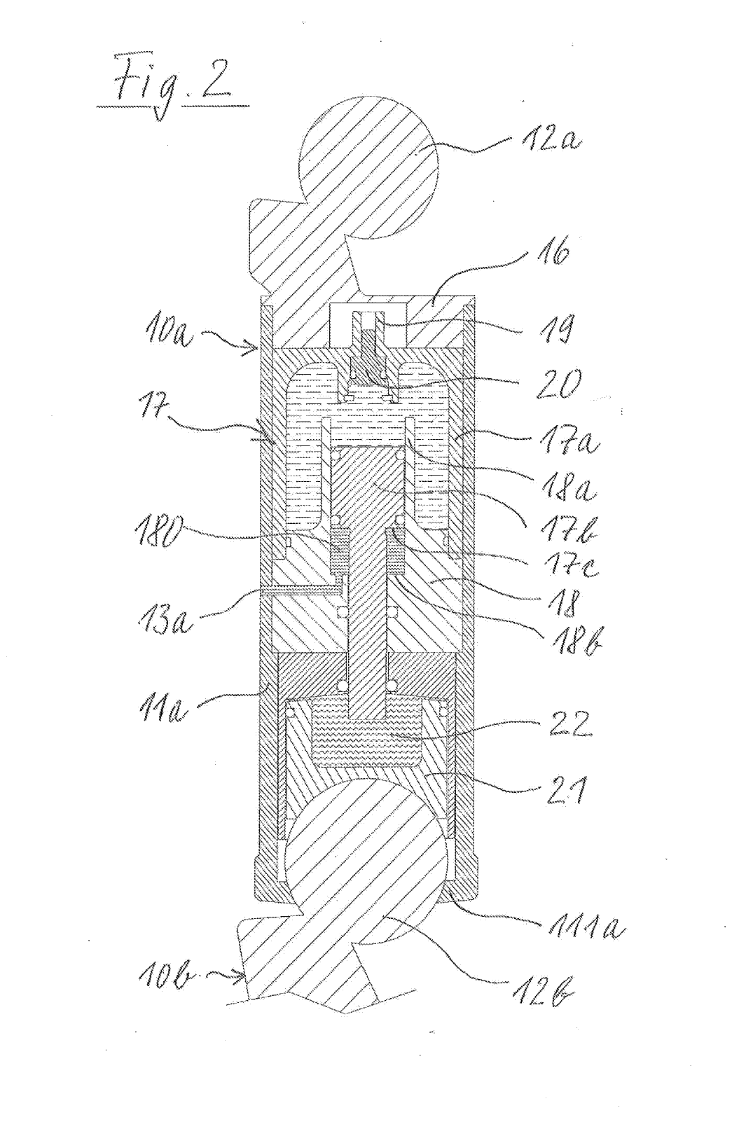

The axial cross-section in FIG. 2 shows the design of the clamping device using the example of the holding arm 10a. It is discernible that the holding arm comprises a cylindrical housing 11a, which is closed at its upper end by a lid 16 carrying the ball joint 12a.

Accordingly, a joint socket for the ball joint 12b of the second holding arm 10b is located at the bottom end of the holding arm 10a. This joint receiver comprises a ring 111a encasing a ball joint 12b and a joint link pan 21 cooperating with the interior of the ball joint 12b, which is supported in the holding arm 10a in an axially displaceable fashion and serves to clamp the ball joint.

Here, it is essential that a gas pressure spring 12 is installed in the upper part of the cylindrical housing 11a. It comprises a cylinder 17a and a control piston 17b, with the control piston 17b exhibiting a considerably smaller diameter than the cylinder 17a. For this purpose, an insert 18 is located at the bottom end of the cylinder 17a, having a cylinder 18a projecting into the cylinder 17a, with its diameter matching the one of the control piston 17b, thus it is considerably smaller than the diameter of the cylinder 17a.

The interior of the cylinder 17a is filled via the gas fill nozzle 19 and a check valve 20 with an inert gas, preferably nitrogen, so that a pressure from 30 to 50 bars develops inside the cylinder chamber.

The gas fill nozzle may be directly accessible from the outside; however it may also be covered by the lid 16, which carries the ball joint 12a.

The control piston 17b crosses the insert 18 and projects at its bottom end into a cylinder chamber 22, located above a secondary piston 21, which serves as a joint socket. The cylinder chamber 22 is filled with hydraulic fluid and exhibits a considerably greater diameter than the control piston 17b. As discernible from the drawing, the cylinder chamber 22 extends in its upper area above the secondary piston 21 to its exterior diameter. This exterior diameter is approximately 5 times the size in reference to the diameter of the control piston 17b. Consequently, the force by which the control piston 17b is pressed downward creates a compression force at the secondary piston and thus at the joint socket 21 approximately 5² times as strong, thus 25-fold. The ball joint 12b is hereby clamped between the joint socket 21 and the ring 111a, so that the holding arm 10b is fixed at the holding arm 10a.

This high compression force at the secondary arm is compensated by a correspondingly long spring travel of the gas pressure spring, thus the control piston 17b. In order for this long spring travel not to lead to a considerable reduction in pressure inside the gas pressure spring, thus in the cylinder 17a, the gas volume is at least 8-fold, preferably at least 10-fold the volume difference realized by the deflection.

As discernible from the drawing, the control piston 17b is stepped, because its lower diameter inserting into the cylinder chamber 22 is smaller than its upper diameter impinged by the gas pressure spring. At its gradation 17c, an annular cylinder chamber 180 is formed in combination with a respective gradation 18b of the insert 18. This cylinder chamber can be impinged via the above-mentioned hydraulic connection 13a with the hydraulic liquid, in order to press the control piston 17b upwards against the gas pressure spring when the clamping device is to be loosened.

The function is as follows: When the connection device is to be clamped in a stiff position, thus the ball joint being clamped between the holding arms, the hydraulic connection 13a responsible for loosening the clamping device is unpressurized. The gas pressure spring 17 then unfolds its full effect, this means the control piston 17b is pressed downwards, penetrates into the cylinder chamber 22 filled with hydraulic liquid, and the joint socket 21 is pressed against the ball joint 12b under the above-mentioned amplified force. Consequently the two holding arms 10a and 10b are then fixed in reference to each other.

However, when the connection device is to be adjusted to a different position or be brought into a limp state, here, preferably operated via a foot pump, hydraulic fluid is pressed via the hydraulic connection 13a into the annular chamber 180, namely with such a pressure that the control piston 17b is pressed upward against the gas pressure in the cylinder 17a of the gas pressure spring. This way, the pressure in the cylinder chamber 22 reduces such that consequently the clamping effect of the joint socket 21 upon the ball joint 12b is released.

The two holding arms 10a and 10b are then articulate in reference to each other and can be adjusted into the desired new position. When said new position has been reached, only the hydraulic connection 13a must be switched unpressurized in order to fix the ball-and-socket joint in this new position.

Therefore the scope of the invention includes to adjust the pressure at the hydraulic connection 13a to arbitrary interim values or gradually in order to this way allow the connection device to not only be switched from a limp to a fixed state but for example 1 or 2 interim states to be achieved, in which the clamping device can be adjusted with minor exterior force. Such interim states may be beneficial if position changes caused merely by gravity shall be excluded, particularly when only small adjustment paths are desired.

Summarizing, the advantage of the invention comprises that a high clamping force at the ball-and-socket joint can be ensured over a longer period of time than in the past, with not even a certain leakage of the hydraulic fluid used for creating the clamping force compromising the compression force.

1. A connection device for the adjustable connection of a medical device to an attachment of a stationary fixture, with the medical device being connectable to one end, and the stationary device to the other end of the connection device, said connection device comprising at least first and second holding arms (10a, 10b, 10c) connected via a ball-and-socket joint, in which the first holding arm (10a) comprises a joint socket (110a), the second holding arm (10b) comprises a matching ball joint (12b), and the ball-and-socket joint can be fixed in a desired angular position by an unlockable clamping device, including at least one pre-stressing element which presses the joint socket (21) against the ball joint (12b) of the second holding arm (10b), and the pre-stressing element comprises a gas pressure spring (17).

2. A connection device according to claim 1, wherein a gas volume of the gas pressure spring (17) is at least 8-fold greater than a difference of a gas volume corresponding to a spring travel of the gas pressure spring.

3. A connection device according to claim 1, wherein the gas pressure spring (17) operates via a transmission gearing to increase a clamping force upon the joint socket (21).

4. A connection device according to claim 3, wherein the transmission gearing is a mechanical transmission, which via gears causes an increase of the clamping force.

5. A connection device according to claim 3, wherein the transmission gearing is a hydraulic transmission, which causes the increase in the clamping force via at least one piston (17b) having different diameters.

6. A connection device according to claim 5, wherein the gas pressure spring (17) acts upon a control piston (17b), which for the purpose of loosening the clamping effect can be impinged from outside with a counter force against a force created by the gas pressure spring.

7. A connection device according to claim 6, wherein the counter force is created hydraulically or pneumatically.

8. A connection device according to claim 7, wherein the holding arm (10a) comprises a hydraulic or pneumatic connection (13a).

9. A connection device according to claim 6, wherein the control piston (17b) penetrates into a cylinder chamber (22), which has a greater diameter in reference to the control piston (17b) and which comprises a secondary piston, which acts on an other side as a joint socket (21) or cooperates therewith.

10. A connection device according to claim 9, wherein at least one of the pistons (17b, 21) is connected via articulate membranes or diaphragms to the allocated cylinder in a sealed fashion.

11. A connection device according to claim 1, wherein the gas pressure spring (17) comprises a fill valve which is accessible from the outside when the gas pressure spring (17) is assembled in the holding arm (10a).
